(19) United States
(12) Patent Application Publication
(10) Pub. No.: US 2009/0098920 A1
(43) Pub. Date: Apr. 16, 2009

(54) Method and System for Auditing and Verifying User Spoken Instructions for an Electronic Casino Game

(75) Inventor: Ragnar Toompere, Douglas (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: WATERLEAF LIMITED, Douglas (GB)

(21) Appl. No.: 11/870,122

(22) Filed: Oct. 10, 2007

(51) Int. Cl. G06F 17/00

(52) U.S. Cl. 463/16; 463/29; 704/243

(57) ABSTRACT

A method and system for auditing and verifying user spoken instructions for an electronic casino game is provided. A player of the electronic casino game may send a query to a manager of the game instructing the manager to retrieve stored records and extract data to verify whether a gaming function that occurred during game play of the casino game properly corresponds to an instruction spoken by the player. An audit trail enables an operator of the casino game to determine what command was actually spoken by the player, the resulting function performed by a gaming server, and whether the gaming function that was performed corresponds correctly to the spoken command.

### FIELD OF INVENTION

The present application relates generally to electronic gaming involving games-of-chance like video slots, video poker and the like and, more particularly, to providing a voice instruction audit trail and verification system. Such electronic games can be played on a computer workstation communicating over a computer network such as the Internet with a central gaming server. Such games can also be played on a workstation taking the form of an electronic video gaming terminal that is installed in a casino-type (brick and mortar) environment, for example.

### BACKGROUND

Video gaming, whether played on-line or on a kiosk in a land-based environment (e.g., an electronic kiosk that houses a computer terminal that employs custom kiosk software and may store data locally or retrieve data from a computer network), includes an interface that enables a player to make game selections and exercise any game play decisions that are necessary in the context of the game. The interface generally includes as output devices a video display on which a simulation of the video game is presented to the player, a speaker system, and tower lights. The interface also includes an input device that could be a pushbutton array, a touch-sensitive screen, a mouse, a keyboard or any other similar device that a player can use to make wagers, game play decisions and generally control progress of the game. In a land-based environment where kiosks are used, input devices are usually pushbuttons and touch screens. In an online environment, a pointing device such as a mouse is a common input device used by players.

Due to recent advances in speech recognition technology, input devices may also include microphones to receive spoken instructions from the user as a means of wagering and making game play decisions. Speech recognition is the process of converting a speech signal to a sequence of words in the form of digital data using any number of algorithms implemented as a computer program.

A performance of a speech recognition system is usually specified in terms of accuracy and speed. Accuracy is measured with a word recognition error rate and speed is measured with a real time factor. Many speech recognition users tend to agree that dictation machines can achieve very high performance in controlled conditions. Many commercial companies assert that speech recognition software can achieve between 98% to 99% accuracy if operated under optimal conditions including matching speaker characteristics with speaker-training data, proper speaker adaptation, and little to no background noise.

A player of an electronic casino game will want 100% accuracy when using a speech input device. As such, an audit trail and speech recognition verification system for electronic games is provided herein.

### SUMMARY

Disclosed herein are embodiments of a method and system for reviewing game play within electronic casino games. The method includes storing a user's voice commands pertaining to game play of an electronic casino game, and receiving an inquiry as to a gaming function performed by a gaming server in response to one of the user's voice commands. The method also includes retrieving from storage the user's voice command corresponding to the inquiry, comparing the user's voice command retrieved from storage with the gaming function performed by the gaming server, and determining if the gaming function that was performed by the gaming server corresponds correctly to the user's voice command. The method further includes responding to the inquiry to indicate whether the gaming function that was performed by the gaming server corresponds correctly to the user's voice command.

In another embodiment, a method of performing an audit of game play within electronic casino games is provided. The method includes receiving an inquiry questioning a gaming function performed by a gaming server in response to a user's spoken voice command, retrieving the user's spoken voice command from storage, and matching the user's spoken voice command with a possible gaining function pertaining to the game play of the electronic casino game. The method also includes making a determination as to whether the gaming function in question matches the possible gaming function, and storing the determination.

In still another embodiment, a system for providing electronic casino games is provided that includes an electronic gaming device presenting a display of game-play and receiving user input via a speech recognition module that is capable of receiving a speech signal at the electronic gaming device and converting the speech signal into digital data. The system also includes a server coupled to the electronic gaming device through a communication network to manage the game-play. The server will receive the speech signal and the digital data from the electronic gaming device, store the speech signal in a database and perform a gaming function in response to the digital data. In response to an inquiry as to the gaming function performed by the server, the server compares the speech signal retrieved from the database with the gaming function performed by the server to determine if the gaming function corresponds correctly to an instruction within the speech signal.

Other aspects of the present disclosure will become apparent from the following detailed description, taken in conjunction with the accompanying drawings, which illustrate, by way of example, certain principles of described embodiments.

### BRIEF DESCRIPTION OF THE DRAWINGS

FIG. 1 is a block diagram illustrating one example of a system for providing electronic casino games to players.

FIG. 2 is a block diagram illustrating another example of a system for providing electronic casino games to players.

FIG. 3 is a flowchart depicting examples of functional steps for verification of game play of an electronic casino game.

### DETAILED DESCRIPTION

Within embodiments discussed below, a method for providing an audit trail of user spoken instructions in an electronic casino game is provided. In addition, a method of verifying the audit trail is discussed to maintain integrity of the electronic casino game. A user or player of the electronic casino game will be able to send a query to a manager of the game that will be able to go retrieve stored records and extract data (e.g., time, date and player input data). The manager may verify the instruction spoken by the user, and the corresponding gaming function that was performed by the electronic casino game to determine if the proper function was performed. The present application applies equally to any type of electronic game where a user inputs instructions using spoken commands.

As an example, a player query may arise out of an erroneous recognition of the player's spoken command by a voice recognition engine of the game. In the game of Blackjack, for example, the player may say “SPLIT”, but the voice recognition engine of the game may recognize the spoken command as “HIT”, which would instruct the game to perform an entirely different function than the intended “SPLIT” function. For this reason, the audit trail enables an operator of the casino game to determine what command was actually spoken by the player, the resulting function performed by the gaming server, and whether the gaming function that was performed corresponded correctly to the spoken command. To perform these functions, the player's spoken commands are stored in a database (along with other identifying data, e.g., date, time, game data, etc.) on the gaming server and can be retrieved to replay a sound bite corresponding to any particular spoken command.

Players may participate in online electronic casino gaming using distributed gaming workstations in which game-play is managed by a central gaming server. U.S. patent application Ser. No. 10/513,140 discloses an example system whereby multiple distributed gaming workstations may engage in gaming activity via a central gaming server over a computer network such as the Internet. The entire contents of U.S. patent application Ser. No. 10/513,140 are incorporated by reference herein, as if fully set forth in this description. In one embodiment, the methods of the present application are implemented in a system of the type disclosed in the U.S. patent application Ser. No. 10/513,140 (published as U.S. Patent Application Publication No. 20060063593).

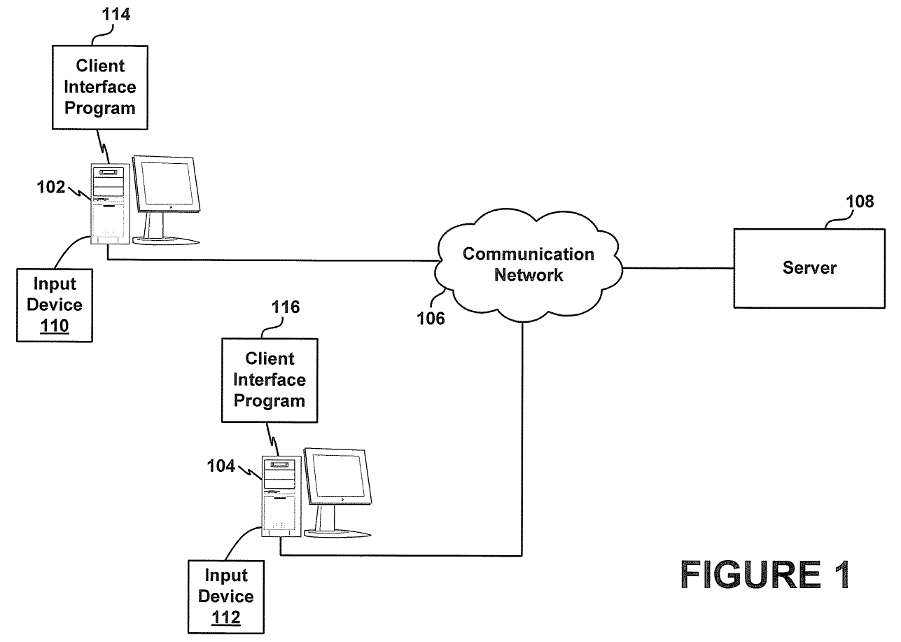

Particularly, referring now to FIG. 1, one example of a system for providing electronic casino games to players is illustrated. The system includes electronic gaming devices 102 and 104 each coupled through a communication network 106 to a server 108. The electronic gaming devices 102 and 104 allow participants (or users, more generally) to play casino games by, for example, presenting the participant a display of game-play. In addition, the electronic gaming devices 102 and 104 may receive user input via input device 110 and input device 112. The electronic gaming devices then transmit the user input through the communication network 106 (such as the Internet) to the server 108 via a wireline or wireless interface, for example. Thus, the electronic gaming devices 102 and 104 may be a slot machine at a live casino, for example, or a personal computer allowing a user to participate in online gaming. One skilled in the art of computer systems will understand that the example embodiments are not limited to any particular class or model of computer employed for the electronic gaming devices 102 and 104 and will be able to select an appropriate system. Further, of course, more electronic gaming devices may be coupled to the server and may allow more players to participate in casino gaming as well.

The server 108 and electronic gaming devices 102 and 104 each may include processors that access memory to execute software functions stored therein to participate in the electronic multiplayer tournaments. The electronic gaming devices 102 and 104 may include any input interface such as those for a standard computer to allow players to participate in the tournaments. In addition, the devices 102 and 104 and the server 108 may include memory, such as random access memory (RAM), or secondary storage, such as read only memory (ROM), optical or magnetic disks, compact-disc read only memory (CD-ROM), or any other volatile or non-volatile storage systems. The memory may store casino client interface programs, client process for a particular casino game or other software programs corresponding to the electronic multiplayer tournaments. In turn, the software programs are executable by the processors to play electronic video games. As such, software programs are executable to display a GUI to the players that may be of a standard type of user interface allowing a user to interact with a computer that employs graphical images in addition to text to represent information and actions available to the user. Actions may be performed through direct manipulation of graphical elements, which include windows, buttons, menus, and scroll bars, for example.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In one embodiment, the system illustrated in FIG. 1 may be in the form of an online casino, and in that instance, the electronic gaming devices 102 and 104 are client workstations and the server 108 is a gaming server remote from the electronic gaming devices 102 and 104, but linked thereto by the communication network 106, such as the Internet. One or more casino games are then executable by selection of a user of the online casino. Each game offered by the casino includes a server process, which is executable in the gaming server, and a client process, which is executable in the client workstation. The server process generates, upon request of the client process, one or more random events upon which an outcome of the casino game depends. Such random events can correspond, for example, to the roll of a die, the spin of a roulette wheel or the deal of a playing card, depending on which particular casino game is being played by the player. The client process, on the other hand, presents to the user or player a simulation of the casino game being played. The client process also enables the player to place wagers on, and to control the progress of, the casino game, and displays to the player the outcome of the game as a function of the random events generated by the server process.

In order to communicate with the gaming server of the online casino, the electronic gaming devices 102 and 104 operate under control of casino client interface programs 114 and 116. The client interface programs 114 and 116 include a menu subsystem or menu selection system that displays to the player a menu of casino games that are offered by the particular online casino. The electronic gaming devices 102 and 104 may present a graphical user interface (“GUI”) including the menu selection system to the players. The players are then able to select any one of the games that they wish to play. When selecting a particular game for the first time, the casino client interface programs 114 and 116 cause a software program corresponding to the client process for the particular casino game to be downloaded from the gaming server 108 to the electronic gaming devices 102 and 104, where the program is stored locally on a storage device, such as a hard disk drive. Once downloaded, the player can then install the software program on the electronic gaming devices 102 and 104. Once the client process for a particular casino game has been downloaded and installed in this manner, the casino game can be played without the necessity for a further download.

In one particular menu selection system, a list of games that are available for play at an online casino is displayed to the player as an unstructured, tiled display of individual game display windows. Each game display window includes a name of a corresponding game, as well as salient details and rules associated with the game. Where a client process associated with a particular game has not yet been downloaded from the gaming server 108 to the electronic gaming devices 102 and 104, the corresponding game display window in the menu subsystem includes an icon that can be activated by the player to initiate a download of the corresponding client process from the gaming server 108 to the electronic gaming devices 102 and 104.

The server 108 may categorize each one of the different casino games available on the server 108 into one or more different categories. Examples of such categories include, for example, progressive jackpot games, table games, video poker games, slots games, and new games that have not previously been accessible through the menu system. The client interface programs 114 and 116 can then present a menu selection system including categorized casino games to the user using any type of GUI or other display techniques.

Many of the games presented by the client interface programs 114 and 116, such as video slots and video poker, generally have a pay table comprising one or more game outcomes, each that have a corresponding payout for a wager on the game. The payouts are generally inversely proportional to the probability of occurrence of the game outcomes, the top payout being commonly referred to as a jackpot prize. The jackpot prize may be a fixed amount or may be a progressive jackpot prize which is funded by a predetermined portion of each eligible wager made by a player of the game. The progressive jackpot prize may be funded by wagers of players playing the game at a single establishment, or may be a wide area progressive jackpot prize that is funded by wagers of players playing the same game at competing establishments. Examples of the operation of wide area progressive jackpot games are disclosed in U.S. patent application Ser. No. 10/532,850, which is entirely incorporated herein by reference, as if fully set forth in this disclosure.

Players may also participate in tournament games, which comprise a multiplayer game. Each participating player in a tournament game is presented with an identical graphical user interface (GUI) on his respective electronic gaming device. The GUI presents to the player a suitable display of game-play with appropriate activatable icons that enable the player to make his own desired game play decisions and to monitor the progress of the multiplayer game by viewing the game play decisions of the other participating players in the same instance of the game. The server 108 monitors and controls game play within a multiplayer wagering tournament game.

During game play, players will operate the electronic gaming devices 102 and 104 using the input devices 110 and 112. The input devices 110 and 112 enable the players to make game selections and exercise any game play decisions that are necessary in the context of the game. The input devices 110 and 112 may be a pushbutton array, a touch-sensitive screen, a mouse, a keyboard, a joystick or any other similar device that a player can use to make wagers, game play decisions and generally control progress of the game. Within exemplary embodiments, the input devices 110 and 112 include microphones and the electronic gaming devices 102 and 104 include speech recognition modules capable of receiving a speech signal (e.g., spoken words from a player) and converting the speech signal into a sequence of words in the form of digital data using any number of algorithms implemented as a computer program.

Any type of speech recognition algorithm or software program may be implemented within the electronic gaming devices 102 and 104. As one example, the speech recognition software may be that provided by Microsoft Windows® speech recognition package, available from the Microsoft Corporation of Redmond, Wash. Many other speech recognition packages and software programs exist as well, and any may be used within the electronic gaming devices 102 and 104 and input devices 110 and 112.

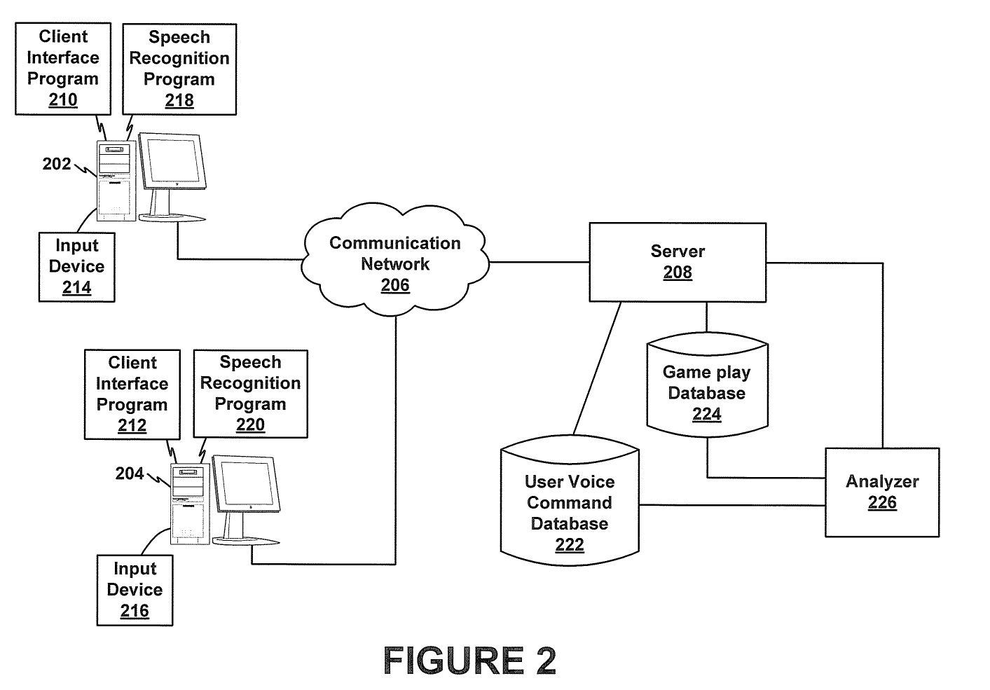

FIG. 2 is another example of a system for providing electronic casino games to players. Similar to the system in FIG. 1, electronic gaming devices 202 and 204 communicate through a communication network 206 with a server 208. Each electronic gaming device 202 and 204 includes a client interface program 210 and 212 and an input device 214 and 216. The electronic gaming devices 202 and 204 also include speech recognition programs 218 and 220. As mentioned, the speech recognition programs 218 and 220 may be any type of commercially available speech recognition program that can analyze spoken words and convert the spoken words into digital data. The speech recognition programs 218 and 220 sample and digitize spoken words to determine a word that was spoken. The speech recognition programs 218 and 220 may be stored within speech recognition modules that may be integral to the electronic gaming devices 202 and 204 or separated from the electronic gaming devices 202 and 204 and operating as a stand-alone component in the system.

The speech recognition programs 218 and 220 will analyze the spoken instructions by a player and send a digital representation of the instructions to the server 208 to indicate the player's game play decision. The electronic gaming devices 202 and 204 may also or alternatively receive the digital representation of the player's spoken instructions and send a representative (or standard) instruction to the server 208 to indicate the player's game play decisions. For example, the player may always be able to use the standard gaming GUI interface to input game play instructions using a mouse or keyboard, and the electronic gaming devices 202 and 204 would then send a standard instruction to the server 208 to indicate the game play.

The electronic gaming devices 202 and 204 could operate to convert the speech recognition programs 218 and 220 outputs into a standard instruction to send to the server 208.

The electronic gaming devices 202 and 204 may also present a real-time verification to the player during game play of the command that was recognized. For example, the player may speak a command, which is then recognized, and the electronic gaming device could then display to the player the command that was recognized. The player can then accept or reject the recognized command, and if the command is not rejected, the game would fulfill the command.

To use the speech recognition programs 218 and 220, a player may need to train the programs to adjust to the player's speaking tones. For example, a player may speak commands, e.g. DEAL, HIT, STAND (or STAY), etc, and the program may display a recognized command. The player can then accept the command as properly recognized, or speak the command again to allow the program to attempt to recognize the spoken words another time.

As an example, the electronic gaming devices 202 and 204 may include a limited dictionary of recognized spoken commands that relate wagering and game play decisions available to a player of the casino video game. In the context of a game of video blackjack, for example, the game play commands could be limited to the following: DEAL, HIT, STAND, SPLIT, DOUBLE, SURRENDER, YES, and NO. If the game is a multi-hand video blackjack game, the dictionary could include other commands such as PLAY N, where n=ONE, TWO, THREE, FOUR or ALL, representing the number of hands of blackjack the player wishes to play in a turn of the game. A limited vocabulary system can recognize a small number of words as spoken by most speakers and may be more reliable than a general or large vocabulary system.

The electronic gaming devices 202 and 204 may also only accept certain instructions at certain times or points within a game. The electronic gaming devices 202 and 204 may note the state of the game being played, and will know the possible moves or game plays available to the player. The electronic gaming devices 202 and 204 may only accept spoken instructions that correspond to a possible game play so as to limit the dictionary of possible acceptable instructions. In turn, chances of erroneously recognizing a spoken instruction may also be lowered.

Each recognized command would, generally, map to a corresponding icon in a simulation of the game on a video display of the electronic gaming device allowing the player to make the game play decisions using a pointing device as well as by spoken command. Alternatively, the icons on the game simulation could be dispensed with entirely.

In a server-based gaming, in which a player can choose any particular game to play from a large number of available games, the recognized command dictionary could be either specific to a single game or, alternatively, could be generic across a number of different variants of the same game. For example, the player may be able to choose a blackjack game from any one of the following example blackjack game variants: Atlantic City rules, Las Vegas rules, or European blackjack. The dictionary could be generic across all the game variants because the same commands apply to all the variants. Similarly, video poker games could require a different dictionary of commands, which could be generic across all video poker game variants.

The electronic gaming devices 202 and 204 could record the spoken instructions by a player and send the recorded spoken instruction to the server 208 to indicate the player's game play decision. The server 208 could then interpret the spoken instruction using a speech recognition program as well. The server 208 also will save each of the player's recorded spoken instructions in a user voice command database 222 to create a record of the player's instructions. The server 208 will also record and store within a game play database 224 an indication of a corresponding game function that was performed in response to each of the user's spoken instructions.

In this manner, the server 208 maintains an audit trail of the player's instructions and the event that occurred in response to the instruction, so that if the player ever questioned the game play, the server 208 could verify whether the proper gaming function was performed. For this purpose, the server 208 may access an analyzer 226 to determine whether proper and correct gaming functions were performed.

The analyzer 226 can access the user voice command database 222 and the game play database 224 to retrieve stored data regarding a user spoken instruction and the responsive game function that was performed. The analyzer 226 can then determine whether the proper game function was performed. In one embodiment, the analyzer 226 includes a person listening to the recorded user spoken instruction to determine what the intended game function was supposed to be, and then can compare the intended game function with the game function that was performed. Alternatively, the analyzer 226 may include a speech recognition program that can receive the stored recorded user spoken instruction, convert the spoken words into digital data, and map the digital data to a corresponding game function. Subsequently, the analyzer 226 would compare the mapped game function with the game function that was performed to determine if the proper game function was performed.

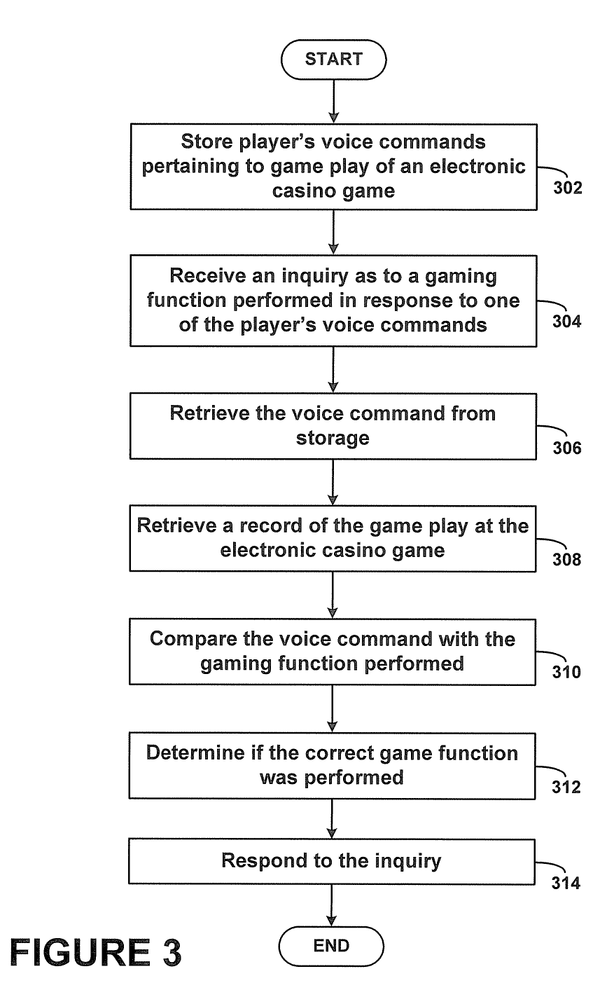

FIG. 3 is a flowchart depicting functional steps for verification of game play of an electronic casino game. It should be understood that each block in this flowchart (and within other flow diagrams presented herein) may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Within exemplary embodiments, a player will use an input device to speak a command or instruction for game play of an electronic game being played on the electronic gaming device. The electronic gaming device will record and send the spoken instruction to the server, which will stores the player's voice command in a database, as shown at block 302. If the player ever questions or wishes to verify that a correct gaming function was performed, the player would send an inquiry to the server. The server would receive the inquiry of a gaming function performed in response to one of the player's voice commands, as shown at block 304.

The server will then retrieve the stored voice command pertaining to the inquiry and a record of game play by the player corresponding to the gaming function in question from databases, as shown at blocks 306 and 308. To do so, the inquiry may include information to specify the time and day of the gaming function in question, the game being played, an identification number of the player and/or of the player's electronic gaming device, and any other information that would be helpful to identify the stored data pertaining to the gaming function in question.

The server will then interpret the voice command to be a gaming instruction and compare the gaming instruction with the actual gaming function that was performed, as shown at block 310. The server will then determine if the correct gaming function was performed as directed by the instruction, as shown at block 312, and respond to the inquiry, as shown at block 314.

Using the method in FIG. 3, the system of the present application includes an audit trail and a game operator may be able to go back through records and extract data (e.g., time, date, player input data, game data, wager information, etc.) to verify game play to maintain the integrity of the game. Every spoken instruction by a player can be recorded and stored.

As a specific example, a player may be playing a game of Blackjack on an electronic gaming device, and may indicate instructions for game play using a microphone. The player may indicate the instruction “SPLIT”, to split his two dealt cards. However, the voice recognition engine within the electronic gaming device may recognize the spoken instruction as “HIT”, and instead of providing the player with two hands, may erroneously deal another card to the player. As a consequence, the player may lose a hand that the player may otherwise have won had the intended instruction been received and performed.

A player query may arise out of the erroneous recognition of the player's spoken command by the voice recognition engine of the game. For this reason, the audit trail enables an operator of an online casino to determine what command was actually spoken by the player, what was the resulting function carried out by the gaming server, and whether the gaming function that was carried out corresponded correctly to the spoken command.

The player inquiry may be received at any time during game-play. For example, the player may notice the mis-recognition of the spoken instruction immediately, and may then pause the game-play to send an inquiry, and have the incorrect gaming function retracted and the correct gaming function performed. In this instance, the server could pause the game-play, perform the audit and verification as outlined in FIG. 3, and if an incorrect gaming function was performed, the server could take appropriate steps (within the context of the game being played) to correct the gaming function. As one example, if during a game of Blackjack, a player said “SPLIT”, but the server received the instruction “HIT” and dealt another card, the server could move the dealt card to be the first card on a new hand created from the SPLIT function. Performing the correct gaming function is dependent on the game being played and the state of the game. It may also be that the best option would be for the server to simply re-deal the hand, and leave wagers in place.

The player could also try to question a gaming function after playing out a hand where an incorrect gaming function occurred, so that if the incorrect gaming function did not lower the player's chance of winning or advancing within the game, the player may simply ignore the incorrect gaming function. The server could reject an inquiry if received in an untimely fashion though, such as after playing out a hand. For some games, the server may require the player to make any inquiries during the hand or sequence at which the potential incorrect gaming function occurred. For example, if during a hand of Blackjack, the server dealt an additional card to the player when the player indicated the instruction “STAY”, in order to question the gaming function of dealing the card, the player may be required to pause the game and send an inquiry while the hand is still being played to have the gaming function corrected.

Times for which an inquiry from the player will be accepted are dependent upon the game being played due to different rules and outcomes of each game. The server may operate within the specific rules for each game, and when possible, may accept inquiries from players questioning a gaming function at many different times during the game play.

Referring back to FIG. 2, ultimately, the server 208 or a casino operator will respond to the inquiry to inform the player whether the proper gaming function was performed, as decided by the analyzer 226. If an improper gaming function was performed, the server 208 may perform additional steps. For example, the server 208 may retrieve information from the game play database 224 regarding an amount of a wager that the player placed during the game play in question and return the wager to the player's account. This assumes that the error was in favor of the casino game. If the error was in favor of the player, e.g., but for the mistaken recognition of the spoken instruction the player would have lost, the server 208 may retrieve information from the game play database 224 regarding an amount of a wager that the player placed during the game play in question and request that the wager be paid by the player. In this scenario, however, there likely will not be a player inquiry questioning the gaming function because it would be to the player's advantage to keep the wager. But, to maintain integrity and honesty, a player could send an inquiry to the server 208 in the event that the player won a wager that the player should not have won, and return the amount of the wager.

Alternatively, the server 208 may attempt to play out a hand of the casino game using the proper instruction to determine if the player would have won the wager. However, using stored game play data to replay a hand using an alternate instruction could change outcomes of each subsequent hand. Using this alternative, it may only be practical for the server 208 to replay one hand using the stored data to play out the hand as desired by the player.

While the present application has been described in the context of fully functional electronic gaming devices and servers, those skilled in the art will appreciate that mechanisms of the present application are capable of being distributed in the form of a computer-readable medium of instructions in a variety of forms, and that the present application applies equally regardless of the particular type of signal bearing media used to actually carry out the distribution. Examples of such computer-accessible devices include computer memory (RAM or ROM), floppy disks, and CD-ROMs, as well as transmission-type media such as digital and analog communication links.

Since many modifications, variations, and changes in detail can be made to the described embodiments, it is intended that all matters in the preceding description and shown in the accompanying drawings be interpreted as illustrative and not in a limiting sense. Further, it is intended to be understood that the following clauses further describe aspects of the present application.

(1) A system for providing electronic casino games comprising:

electronic gaming devices presenting a display of game-play and receiving user input via input devices;

speech recognition modules capable of receiving a speech signal at the electronic gaming devices and converting the speech signal into digital data; and

a server coupled to the electronic gaming devices through a communication network, the server receiving the speech signal from the speech recognition modules and storing the speech signal in a database, wherein in response to an inquiry as to a gaming function performed by the server in response to one of the speech signals, the server compares the speech signal retrieved from the database with the gaming function performed by the server to determine if the gaming function corresponds correctly to an instruction within the speech signal.

(2) The system of clause (1), wherein the electronic gaming devices are remote from server.

(3) The system of clauses (1) or (2), further comprising a server process executable in the server, and a client process executable in the electronic gaming devices, wherein the server process generates, upon request of the client process, one or more random events upon which an outcome of the casino game depends.

(4) The system of clauses (1), (2) or (3), wherein the input devices include a pushbutton array, a touch-sensitive screen, a mouse, a keyboard, or a joystick.

(5) The system of clauses (1), (2), (3) or (4), further comprising presenting a real-time verification to a player during game play of a speech signal that was recognized.

(6) The system of clauses (1), (2), (3), (4) or (5), wherein the speech recognition modules only accept certain instructions at certain times within a game.

(7) The system of clauses (1), (2), (3), (4), (5) or (6), wherein the electronic gaming devices identify a state of the game being played, and determine possible game plays available to the player so as to only accept spoken instructions that correspond to the possible game plays.

(8) The system of clauses (1), (2), (3), (4), (5), (6) or (7), wherein each recognized spoken instruction maps to a corresponding icon in a simulation of the game on a video display of the electronic gaming device allowing the player to make game play decisions using a pointing device as well as by spoken command.

(9) A method for verifying game play of an electronic casino game comprising:

a player using an input device to speak a command or instruction for game play of an electronic game being played on the electronic gaming device;

recording and sending the spoken instruction to a server;

storing the spoken instruction in a database;

receiving an inquiry of a gaming function performed in response to one of the spoken instructions;

retrieving the stored spoken instruction pertaining to the inquiry and a record of game play corresponding to the gaming function in question;

interpreting the retrieved spoken instruction to be a gaming instruction;

comparing the gaming instruction with the gaming function that was performed;

determining if a gaming function was performed as intended by the gaming instruction; and

responding to the inquiry to indicate if the gaming function was performed as intended by the gaming instruction.

(10) The method of clause (9), wherein if an improper gaming function was performed, the method further comprises retrieving information regarding an amount of a wager that was placed during the game play in question and returning the wager to the player

(11) The method of clauses (9) or (10), wherein the inquiry includes a time and date corresponding to the gaming function in question and player data corresponding to the user who provided the voice command in question, and wherein retrieving from storage the user's voice command corresponding to the inquiry comprises retrieving the user's voice command corresponding to the time and date of the gaming function in question and to the player who provided the voice command in question.

(12) The method of clauses (9), (10) or (11), wherein the game play of the electronic casino game corresponds a distributed online game in which a client software program on a user's computer communicates with a server software program on the gaming server, and wherein the server software program generates one or more random events upon which an outcome of the electronic casino game depends, and wherein the client software program presents to the user on the user's computer a simulation of the electronic casino game being played and receives from the user spoken voice commands indicating the user's play.

(13) The method of clauses (9), (10), (11) or (12), wherein the game play of the electronic casino game corresponds to a multi-player distributed online game.

(14) The method of clauses (9), (10), (11), (12) or (13), wherein a limited number of gaming functions may be performed by the gaming server, and wherein the method further comprises interpreting the user's voice command retrieved from storage to correspond to one of the limited number of gaming functions.

(15) The method of clauses (9), (10), (11), (12), (13) or (14), wherein comparing the user's voice command retrieved from storage with the gaming function performed by the gaming server comprises listening to the voice command spoken by the user, deciding what command was spoken, matching the command that was spoken with a possible command pertaining to the game play of the electronic casino game, and determining if the possible command pertaining to the game play of the electronic casino game instructs the electronic casino game to perform the gaming function.

(16) A method for verifying game play of an electronic casino game comprising:

a player using an input device to speak a command or instruction for game play of an electronic game being played on the electronic gaming device;

recording and sending the spoken instruction to a server;

storing the spoken instruction in a database;

receiving an inquiry of a gaming function performed in response to one of the spoken instructions;

if the inquiry is received after a given sequence of game play is completed, rejected the inquiry; and

if the inquiry is received during the given sequence of game play (i) retrieving the stored spoken instruction pertaining to the inquiry and a record of game play corresponding to the gaming function in question, (ii) interpreting the retrieved spoken instruction to be a gaming instruction, (iii) comparing the gaming instruction with the gaming function that was performed, (iv) determining if a gaming function was performed as intended by the gaming instruction, and (iv) responding to the inquiry to indicate if the gaming function was performed as intended by the gaming instruction.

(17) The method of clause (16), further comprising pausing the game-play determine if a correct gaming function was performed.

A computer readable medium containing program code for causing a processor to execute the method of any of clauses (9), (10), (11), (12), (13), (14), (15), (16) or (17).

Various embodiments have been described. Those skilled in the art will understand, however, that changes and modifications may be made to the embodiments described without departing from the true scope and spirit of the present invention, which is defined by the following claims.

What is claimed is:

1. A method of reviewing game play within electronic casino games comprising:
storing a user's voice commands pertaining to game play of an electronic casino game;
receiving an inquiry as to a gaming function performed by a gaming server in response to one of the user's voice commands;
retrieving from storage the user's voice command corresponding to the inquiry;
comparing the user's voice command retrieved from storage with the gaming function performed by the gaming server;
determining if the gaming function that was performed by the gaming server corresponds correctly to the user's voice command; and
responding to the inquiry to indicate whether the gaming function that was performed by the gaming server corresponds correctly to the user's voice command.

2. The method of claim 1, wherein the inquiry includes a time and date corresponding to the gaming function in question and player data corresponding to the user who provided the voice command in question, and wherein retrieving from storage the user's voice command corresponding to the inquiry comprises retrieving the user's voice command corresponding to the time and date of the gaming function in question and to the player who provided the voice command in question.

3. The method of claim 1, wherein the game play of the electronic casino game corresponds a distributed online game in which a client software program on a user's computer communicates with a server software program on the gaming server, and wherein the server software program generates one or more random events upon which an outcome of the electronic casino game depends, and wherein the client software program presents to the user on the user's computer a simulation of the electronic casino game being played and receives from the user spoken voice commands indicating the user's play.

4. The method of claim 3, further comprising:
the client software program interpreting the user spoken voice commands; and
sending an instruction from the user's computer to the gaming server indicating the user's play.

5. The method of claim 3, further comprising:
sending the user spoken voice command from the user's computer to the gaming server; and
the server software program interpreting the user spoken voice commands.

6. The method of claim 1, wherein the game play of the electronic casino game corresponds to a multi-player distributed online game.

7. The method of claim 1, further comprising retrieving a record of the gaming function performed by the gaming server corresponding to the gaming function in question from the inquiry.

8. The method of claim 1, wherein a limited number of gaming functions may be performed by the gaming server, and wherein the method further comprises interpreting the user's voice command retrieved from storage to correspond to one of the limited number of gaming functions.

9. The method of claim 8, wherein determining if the gaming function that was performed by the gaming server corresponds correctly to the user's voice command comprises determining if the gaming function that was performed by the gaming server was the one of the limited number of gaming functions.

10. The method of claim 1, further comprising:
receiving the user's voice commands pertaining to game play of the electronic casino game; and
presenting a verification to the user during game play of a gaming function that will be performed in response to the user's voice commands.

11. The method of claim 1, further comprising:
identifying a state of the electronic casino game being played;
determining possible game plays available to the user at the state; and
interpreting the user's voice command retrieved from storage to correspond to one of the possible game plays.

12. The method of claim 1, further comprising interpreting the user's voice command retrieved from storage to decide what gaming function the user intended to be performed.

13. The method of claim 1, wherein comparing the user's voice command retrieved from storage with the gaming function performed by the gaming server comprises:
listening to the voice command spoken by the user;
deciding what command was spoken;
matching the command that was spoken with a possible command pertaining to the game play of the electronic casino game; and
determining if the possible command pertaining to the game play of the electronic casino game instructs the electronic casino game to perform the gaming function.

14. The method of claim 1, wherein if the gaming function that was performed by the gaming server does not correspond correctly to the user's voice command:
retrieving a record of an amount of a wager placed and lost by the user during game play for the gaming function in question; and
returning the amount of the wager to the player.

15. A computer readable medium containing program code for causing a processor to execute the method of claim 1.

16. A method of performing an audit of game play within electronic casino games comprising:
receiving an inquiry questioning a gaming function performed by a gaming server in response to a user's spoken voice command;
retrieving the user's spoken voice command from storage;
matching the user's spoken voice command with a possible gaming function pertaining to the game play of the electronic casino game;
making a determination as to whether the gaming function in question matches the possible gaming function; and
storing the determination.

17. The method of claim 16, wherein matching the user's spoken voice command with the possible gaming function pertaining to the game play of the electronic casino game comprises listening to the user's spoken voice command.

18. The method of claim 16, wherein a limited number of gaming functions may be performed by the gaming server, and wherein the method further comprises interpreting the user's spoken voice command retrieved from storage to correspond to one of the limited number of gaming functions.

19. The method of claim 16, further comprising:
identifying a state of the electronic casino game being played;
determining possible game plays available to the user at the state; and
only accepting user voice commands that correspond to one of the possible game plays.

20. The method of claim 16, wherein if the gaming function in question does not match the possible gaming function, the method further comprises:
retrieving a record of an amount of a wager placed and lost by the user during game play for the gaming function in question; and
returning the amount of the wager to the player.

21. A method for verifying game play of an electronic casino game comprising:
storing a user's voice commands pertaining to game play of an electronic casino game;
receiving an inquiry as to a gaming function performed by a gaming server in response to one of the user's voice commands;
if the inquiry is received after a given sequence of the game play is completed, rejecting the inquiry; and
if the inquiry is received during the given sequence of game play, performing an audit to identify a given gaming function that should have been performed in response to the one of the user's voice commands and verifying whether the given gaming function was performed.

22. The method of claim 21, wherein performing the audit comprises:
retrieving from storage the user's voice command corresponding to the inquiry;
comparing the user's voice command retrieved from storage with the gaming function performed by the gaming server;
determining if the gaming function that was performed by the gaming server corresponds correctly to the user's voice command; and
responding to the inquiry to indicate whether the gaming function that was performed by the gaming server corresponds correctly to the user's voice command.

23. A system for providing electronic casino games comprising:
an electronic gaming device presenting a display of game-play and receiving user input via a speech recognition module, the speech recognition module capable of receiving a speech signal at the electronic gaining device and converting the speech signal into digital data; and
a server coupled to the electronic gaming device through a communication network to manage the game-play, the server receiving the speech signal and the digital data from the electronic gaming device, storing the speech signal in a database and performing a gaming function in response to the digital data, wherein in response to an inquiry as to the gaming function performed by the server, the server compares the speech signal retrieved from the database with the gaming function performed by the server to determine if the gaming function corresponds correctly to an instruction within the speech signal.

24. The system of claim 23, wherein a limited number of gaming functions may be performed by the server so that the server interprets the speech signal to correspond to one of the limited number of gaming functions.

25. The system of claim 23, wherein the server identifies a state of the game-play, determines possible game plays available to the user at the state, and interprets the speech signal to correspond to one of the possible game plays.
